(19) United States
(12) Patent Application Publication
(10) Pub. No.: US 2014/0300322 A1
(43) Pub. Date: Oct. 9, 2014

(54) Wire Arrangement for USB Charger Devices

(71) Applicant: Tseng-Lu Chien, Walnut, CA (US)

(72) Inventor: Tseng-Lu Chien, Walnut, CA (US)

(21) Appl. No.: 13/858,604

(22) Filed: Apr. 8, 2013

(51) Int. Cl. H02J 7/00

(52) U.S. Cl. CPC H02J 7/0042
USPC 320/114

(57) ABSTRACT

The current invention for wire arrangement for USB Charger related products which offer a very simple wire arrangement for people for the USB-Charger wires for different models of the smart phone, ipad, iphone, camera or any other electric or digital data device while people to use, storage, carry, travel without meet the a mess wire situation again. The add-on wire arrange-means are separated piece to add on the said USB Charger related products. The Build-In wire arrange-means are build with the said USB Charger related products. The said USB Charger related products at least has one USB Charger incorporate with any combination of selected device including USB charger, Outlets device, Sensor Device, Motion Sensor device, Remote control device, time device, LED light device, light device, illumination device, power fail device, smell device, voice device or other electric or electronic devices to form a more than one function products.

### BACKGROUND

The current invention is Continuously or Division filing for co-pending filing case as below which are mainly for

(A) Rotating LED light device has outlets or electric receiving sockets means US Co pending filing Ser. No. 12/950,017 filed on Nov. 19, 2010
(B) Electric device has build in Universal USB-unit(s) and Outlet-unit(s) US Co Pending Filing Ser. No. 13/117,227 filed on May 27, 2011
(C) Desk Top LED device has USB-unit(s) or Outlet-Unit(s) to charge electric or digital device US co pending filing U.S. Ser. No. 13/161,643 filed on Jun. 16, 2011
(D) Multiple Function LED night light U.S. Ser. No. 11/806,285 filed on May 31, 2007

And also CIP filing for the following LED related filing cases:

(1) Project light (2) More than one function (3) adjust focus (4) adjust angle (5) Elastic contact points (6) LED heat solution (7) Heat sensitive parts installation (8) extend means are disclosure all below listed co-pending and patented as prior arts still fall within the current invention as below:

U.S. Ser. No. 13/367,758, U.S. Ser. No. 13/367,687, U.S. Ser. No. 13/296,508, U.S. Ser. No. 13/295,301, U.S. Ser. No. 13/021,107, U.S. Ser. No. 12/950,017, U.S. Ser. No. 12/938,564, U.S. Ser. No. 12/886,832, U.S. Ser. No. 12/876,507, U.S. Ser. No. 12/771,003, U.S. Ser. No. 13/021,124, U.S. Ser. No. 12/624,621, U.S. Ser. No. 12/622,000, U.S. Ser. No. 12/318,470, U.S. Ser. No. 12/914,584, U.S. Ser. No. 12/834,435, U.S. Ser. No. 12/292,153. U.S. Ser. No. 12/907,443, U.S. Ser. No. 12/232,505, U.S. Ser. No. 11/806,711, U.S. Ser. No. 11/806,285.

The current invention is continuously filing for Ser. No. 13/295,301 “The Device has build-in Digital Data means and Powered by unlimited power source of light device”.

The current invention is continuously filing for Ser. No. 13/296,508 “The Device has build-in Digital Data means and power unlimited power source of LED Bulb”

The current invention is continuously filing for Ser. No. 13/296,460 “The device has build-in Digital data means and powered by unlimited power source of Lamp Holder.

These (3) co-pending filing are continuously filing of Ser. No. 12/951,501 “Lamp Holder has build-in LED Night light”

The current invention is continuously filing for Ser. No. 12/950,017 “Multiple surface LED light”

All these are continuously filing for Ser. Nos. 13/296,508, 13/295,301, 13/296,469 are continuously filing for Ser. No. 13/162,824 Light device with display means has track-means and removable LED-unit(s) which are the continuously filing for Ser. No. 12/938,628 LED light fixture has outlet(s) and removable LED unit(s) and for Ser. No. 12/887,700 Light fixture with self-power removable LED unit(s). Those are continuously filing for Ser. No. 12/149,963 (Now patented U.S. Pat. No. 7,722,230), Ser. No. 12/073,095 (Now U.S. Pat. No. 7,726,869), Ser. No. 12/073,889 (Co-Pending Filing), Ser. No. 12/007,076 (Now patented U.S. Pat. No. 7,726,841), Ser. No. 12/003,691 (Now U.S. Pat. No. 7,726,839), Ser. No. 12/894,865 (Co-Pending Filing).

This is continuation of U.S. patent application Ser. No.

Ser. Nos. 12/624,621, 12/622,100, 12/318,471, 12/318,470, 12/318,473, 12/292,153, 12/232,505, 12/232,035, 12/149,963, 12/149,964, 12/073,095, 12/073,889, 12/007,076, 12/003,691, 12/003,809, 11/806,711, 11/806,285, 11/806,284, 11/566,322, 11/527,628, 11/527,629, 11/498,874, 12/545,992, 12/806,711, 12/806,285, 12/806,284, 12/566,322, 12/527,628, 12/527,629, 12/527,631, 12/502,661, 11/498,881, 11/255,981, 11/184,771, 11/152,063, 11/094,215, 11/092,742, 11/092,741, 11/094,156, 11/094,155, 10/954,189, 10/902,123, 10/883,719, 10/883,747, 10/341,519, 12/545,992, 12/292,580, 12/710,918, 12/624,621, 12/622,000, 12/318,471, 12/318,470, 12/318,473, 12/292,153, 12/710,561, 12/710,918, 12/711,456, 12/771,003

This is Division of U.S. patent application Ser. No. ______ field on Nov. 11, 2011 for The Device has build-in digital data means and powered by unlimited power source for Lamp holder.

This is Division of U.S. patent application Ser. No. ______ field on Nov. 11, 2011 for The Device has build-in digital data means and powered by unlimited power source for light Device.

This is continuously of U.S. patent application Ser. No. 12/951,501 field on Nov. 20, 2010 for Lamp Holder has build-in LED light.

This is continuously of U.S. patent application Ser. No. 12/771,003 field on Apr. 29, 2010 for LED light has geometric-unit(s) incorporated project means.

This is continuously of U.S. patent application Ser. No. 12/711,456 Field on Feb. 25, 2010 for LED power failure Light

This is continuously of U.S. patent application Ser. No. 12/710,561 Field on Feb. 25, 2010 for LED light device has special effects

This is continuously filing of U.S. patent application Ser. No. 12/710,918 Field on Feb. 25, 2010 for LED light device has more than 1 reflective means for plurality of image
This is continuation of U.S. patent application Ser. No 12/624,621 Field on Nov. 24, 2009 file for the “project device or assembly for variety of LED light”
This is continuation of U.S. patent application Ser. No 12/622,000 Field on Nov. 24, 2009 file for the “Interchangeable Universal Kits for all LED light”
This is continuation of U.S. patent application Ser. No. 12/318,471 Field Dec. 30, 2008 file for the “LED night light with pinhole imaging”
This is continuation of U.S. patent application Ser. No. 12/318,470 Field Dec. 24, 2008 file for the “LED night light with Projection features”
This is continuation of U.S. patent application Ser. No. 12/318,473 Field Dec. 8, 2008 file for the “LED night light with laser or hologram element”

This is continuation of U.S. patent application Ser. No. 12/292,153 Field Nov. 8, 2008 file for the “LED night light with Projection or imaging features”
This is continuation of U.S. patent application Ser. No. 12/232,505 Field Sep. 16, 2008 file for the “LED night light with Projection features”

This is continuation of U.S. patent application Ser. No. 12/149,963 Filed on Apr. 21, 2008 file for the “Removable LED light device.
This is continuation of U.S. patent application Ser. No. 12/149,964 Filed on Apr. 21, 2008 file for the “Surface Mounted device with LED light”.
This is continuation of U.S. patent application Ser. No. 12/073,095 Filed on Feb. 29, 2008 file for the “LED Track light device.
This is Continuation of U.S. patent application Ser. No. 12/073,889, filed on Feb. 12, 2008 file for the” LED light with changeable position with Preferable power source“.
This is Continuation of U.S. patent application Ser. No. 12/007,076, filed on Jan. 7, 2008 file for the” LED light with changeable geometric system”
This is Continuation of U.S. patent application which the Ser. No. 12/003,691, filed on Dec. 31, 2007 file for the “LED light with changeable geometric dimension features”
This is Continuation of U.S. patent application which the Ser. No. 12/003,809, filed on Jan. 2, 2008 file for the “LED light with changeable features”
This is Continuation of U.S. patent application which the Ser. No. 11/806,711 filed on Apr. 30, 2007 file for the “Multiple LED light with adjustable angle features”

This application is continuation of U.S. patent application Ser. No. 11/806,285. LED Night light with outlet device filed on Apr. 30, 2007

This application is continuation of U.S. patent application Ser. No. 11/806,284 LED Night light with more than 1 optics means filed on Apr. 28, 2007

This application is continuation of U.S. patent application Ser. No. 11/527,628. Multiple function Night light with air fresher filed on Sep. 27, 2006.

This application is continuation of U.S. patent application Ser. No. 11/527,629. LED Night light with interchangeable display unit filed on Sep. 27, 2006.

This application is continuation of U.S. patent application Ser. No. 11/498,874. Area illumination Night light filed on Aug. 4, 2006.

This application is continuation of U.S. patent application Ser. No. 11/527,631. LED Time piece night light field on Sep. 27, 2006.

This application is continuation of U.S. patent application Ser. No. 12/545,992 LED time piece Night light filed division of 11/527,631 on Aug. 24, 2009.

This application is continuation of U.S. patent application Ser. No. 12/292,580 LED Time Piece Night light filed division of 11/527,631 on Aug. 24, 2009.

This application is continuation of U.S. patent application Ser. No. 11/498,881, Poly Night light filed on Aug. 4, 2006.

This application is continuation of U.S. patent application Ser. No. 11/255,981, Multiple light source Night Light filed on Oct. 24, 2005.

This application is continuation of U.S. patent application Ser. No. 11/184,771 Light Device with EL elements field on Oct. 11, 2005

This application is continuation of U.S. patent application Ser. No. 11/1152,063 Outlet adaptor with EL field on Jun. 5, 2005

This application is continuation of U.S. patent application Ser. No. 11/094,215 LED night light with liquid medium filed on Mar. 31, 2005

This application is continuation of U.S. patent application Ser. No. 11/094,215, filed Mar. 30, 2005 LED Night light with Liquid optics medium.

This application is continuation of U.S. patent application Ser. No. 11/092,741, filed Mar. 30, 2005 Night light with fiber optics.

This application is continuation of U.S. patent application Ser. No. 10/883,747, filed Jul. 6, 2004 Fiber Optic light kits for footwear.

This application is continuation of U.S. patent application Ser. No. 11/498,874, Area Illumination for LED night light

This application is continuation of U.S. patent application Ser. No. 11/527,629. Time Piece with LED night light,

This application is continuation of U.S. patent application Ser. No. 11/527,628. Multiple Function Night light with Air Freshener

This application is continuation of U.S. patent application Ser. No. 11/806,284 LED Night light with more than one optics mediums

This application is continuation of U.S. patent application Ser. No. 11/806,285 LED Night Light with multiple function

This application is continuation of U.S. patent application Ser. No. 11/806,711 Multiple LEDs Light with adjustable angle function

The current invention incorporate with above listed co-pending or patented cases' features, construction still fall within the current inventions scope and all related equivalent function or replace parts also should fall within the current invention.

The current invention for wire arrangement for USB Charger related products. The said USB Charger related products which means the products at least have one

### DRAWING

FIG. 1: Disclosure the 1^{st} embodiment for Wire arrangement for USB Charger Or USB Charger related product. The Add-On wire arrange-means at install On the said USB charger which has 2 USB ports and foldable prong. The details description on the notes of the FIG. 1 to save examiner cross reference for number and drawing.

FIG. 2 and FIG. 3 and FIG. 4 and FIG. 5: Disclosure the 2^{nd} and 3rd and 4^{th} and 5^{th} embodiment of the said the add-on wire arrange-means (Also can marked as manage-means) which are made by soft and elastic material or other preferred material so can easily install, wrap, add to the inner USB charger or USB Charger related products to make all kind of wire been well organization for charging or carry or travel. The details description on the notes of the FIG. 2 and FIG. 3 and FIG. 4 and FIG. 5. to save examiner cross reference for number and drawing.

FIG. 6-1 and FIG. 6-2 and FIG. 6-3 and FIG. 6-4: Disclosure the 5^{th} embodiment of the said Add-On wire arrange-means which are made by more than one piece of the parts to assembled together to form a space or gap or construction to allow the wire or all different wires to well fit within the space, gap, construction dimension with hold means to fix at least partial of wire, charging plug or USB plug on position. The details description on the notes of the FIG. 6-1 and FIG. 6-2 and FIG. 6-3 and FIG. 6-4. to save examiner cross reference for number and drawing.

FIG. 7 and FIG. 8: Disclosure the 6^{th} and 7th embodiment has construction Parts to form space, gap, dimension to allow apply simple physics and mechanical theory to make wire arrangement by twist the top cover and well received or coil or release the wire when people carry or charging the other electric devices. The difference for FIG. 7 which the inner USB Charger already has its own safety certification so no need to get all construction parts for safety authorities testament anymore. The FIG. 8 which the inner USB Charger are designed with the all other construction parts so it have to pass safety authority testament for all parts on this embodiment. That means the FIG. 7 can be universal for all existing safety listed USB Charger or USB Charger relative products. But, The FIG. 8 have to one by one to do safety testament which is not belong to Universal application. So the FIG. 7 is add-on Piece and FIG. 8 is Built-in Device. This is simple definition for Add-On and Build-in difference. The details description on the notes of the FIG. 7 and FIG. 5. to save examiner cross reference for number and drawing.

FIG. 9: Disclosure the 8th embodiment similar with FIG. 8 for construction for Built-In wire arrange-means. The details description on the notes of the FIG. 9. to save examiner cross reference for number and drawing.

FIG. 10 (#1 to #18): Disclosure all different USB Charger and USB Charger related products for different combination(s) has the add-on or the Built-In wire arrangement. The said USB Charger related products definition as below: The said USB charger or USB charger related products has at least one of the USB Charger incorporate with device(s) in group combinations selected from more USB charger device(s), Outlet device(s), LED light device(s), Time piece device(s), Motion Sensor device(s), Remote control device(s), Smell Device(s), Motion Device(s), Animation Device(s), audio device(s), video device(s), Internet device(s), digital data device(s) or other electric or electronic device(s) available from market place to become a more than one function(s) product(s). The details description on the notes of the FIG. 10 (#1 to #18), to save examiner cross reference for number and drawing.

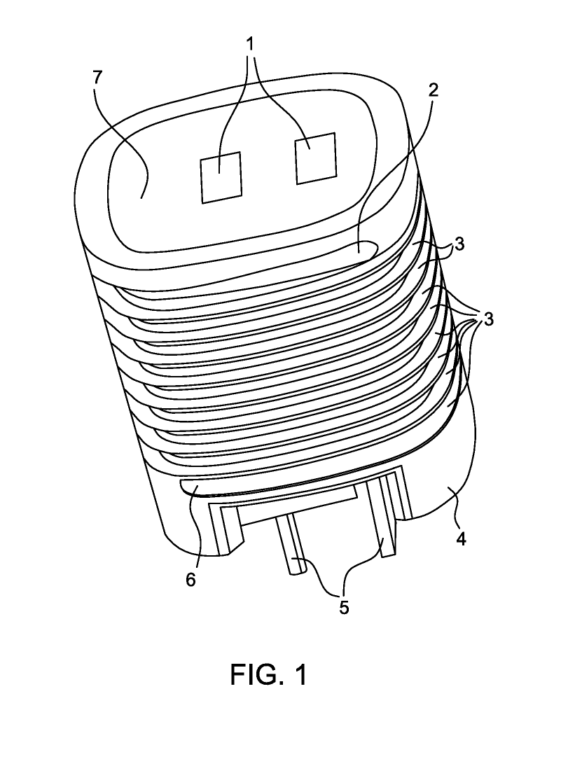

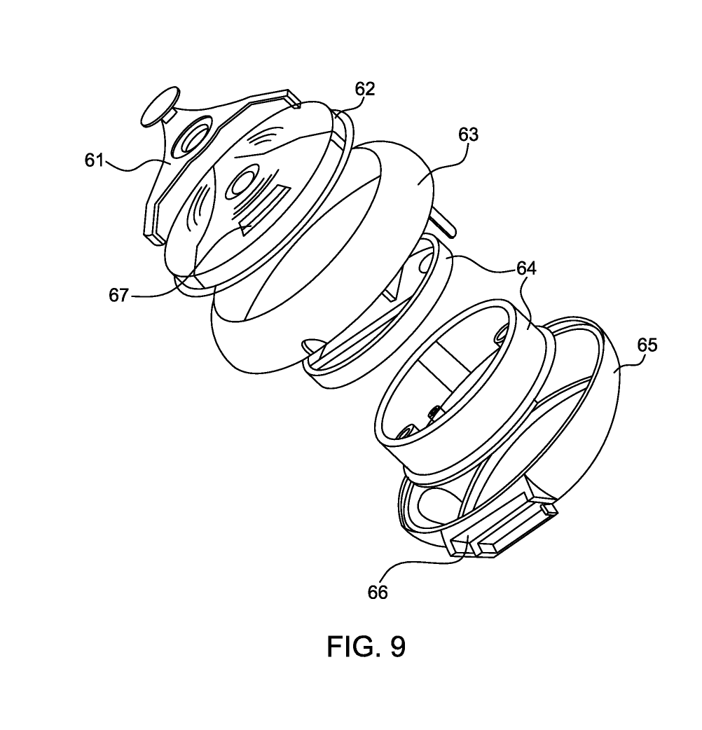

These FIG. 1 to FIG. 10, are the some drawing and concepts of the current invention, It is appreciated, that any similar concept or equivalent application or same purpose or same physics theory or close acknowledgements still fall within the inventor's scope or wording or mind and claims coverage without any limitation as long as the same mind or concept or purpose to make the wire arrangement for USB Charger or USB Charger related products discussed or mentioned within this filing application in single word, phase, sentence or drawing notes.

The details description besides the Figure notes as below:

### DETAIL DESCRIPTION

From FIG. 1 to FIG. 10 (#1 to #18) all drawing the notes, the current invention has the unique concept including:

From FIG. 1: The wire arrange-means which may in the form of groove, ditch, channel, cut-outs to allow the wire fit within to keep wire well arrangement on the add-on piece or built-in piece of the safety approval USB Charger or the USB Charger related products. Which the said safety approval means the USB Charger or the USB charger related products been tested by UL or the other laboratories and meet all USA safety standard requirement for different ruling and get the UL or other authorities certification.

The Said USB charger or USB charger related products may in any size, shade, multiple functions or more than one functions which may any combination selected from group combinations from USB Charger, LED light device, Motion sensor device, Remote control device, audio device, video device, internet device, digital data transmission devices, or other market available electric or electronic device.

The USB charger's port which may variable from No. 1 to No. (N-any number) for USB charger device, It also many has multiple functions which may incorporate with preferred combinations may selected from USB device, outlets device, sensor device, motion sensor device or other any conventional market device(s). The receiving ports may for USB plug, outlets plug, sound plug, video plug, or market available plug has electric functions.

The safety approval with its safety certification USB Charger or USB charger related products has more than one functions.

The add-On arrange-means has optional selection to have the wire input-end and wire-output end with at least one of the holder means to hold the at least partial

Charger-USB wire or other wires, charger plug, USB plug depend on how good product need to required by market place.

The add-ON arrange-means is separated from the said USB Charger or USB Charger related products so allow the people to remove or replace it while needed.

The USB Charger or USB Charger related product may have foldable prong to connect with wall outlets to get power source though the USB Charger or USB charger related product(s) circuit then supply power to the said other device(s).

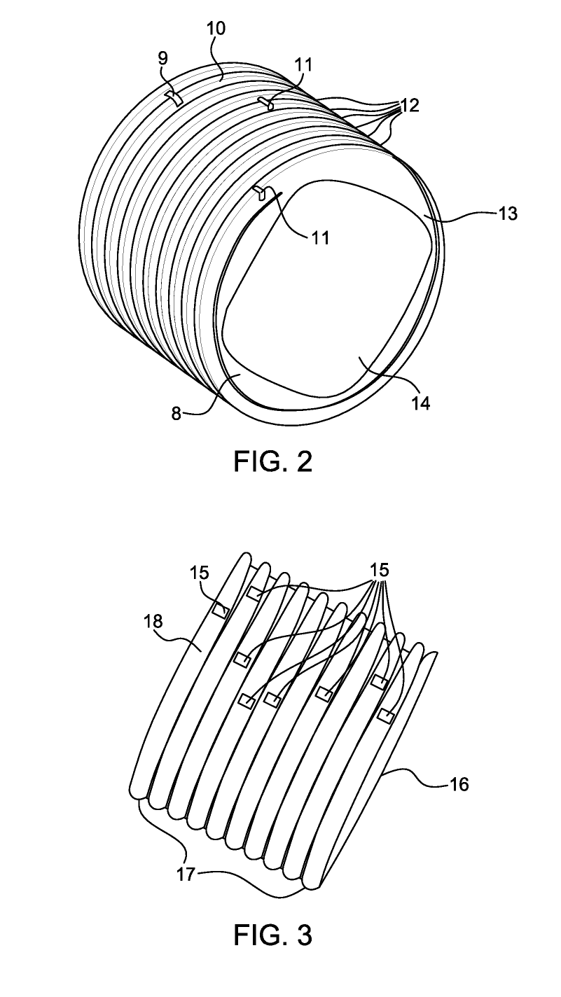

From FIG. 2: the notes including the Add-on or built-in wire arrange-means may have optional groove, ditch, channel, cut-outs, space, construction, designs to well arrange the wires within or fit-in. The Cutouts may be more than one and located on anywhere so can allow people to install on desire position and make the Charger-Plug or the USB-Plug with some preferred wire length hanging there for easier use.

The cut-outs position may become the wire input-end or output-end so can let the people can fit the wires as they like for certain arrangement and not only said whole wires been coiled or released. This is the features for the for many accurate cut-outs are offer more combination to make wire arrangement on the said USB charger or USB charger related products.

Further more, the FIG. 2 and FIG. 3 and FIG. 4 disclosure the groove, ditch, channels, cutouts preferred to made of soft and elastic material such as silicone or rubber or whatever are soft to allow the people can easily put the wire(s) groove, ditch, channels, cutout(s). The preferred such groove, ditch, channel, cutouts has little narrow width than wire's diameter so can easily press and tighten the wire on location. The depth preferred to have bigger than the wire's diameter so wire can whole diameter fall within the depth of wire arrange-means to protect the wire been scratch/heat/Fire/UV or other damage. The cut-out(s) need same as the width and depth preferred size so can hold the wires on position well.

The Inner hollow space for the Add-On wire arrange-means which allow the USB Charger or USB Charger related products to fit within by physical fitting or equipment while make mass production.

The preferred construction for the groove, ditch, channel, Cut-outs preferred design as screw-thread which from input-end to output-end is in one continuously smooth linear one path so can make the wire easily coiled and release without cross walls and make a mess.

The said Add-On or Built-in wire arrange-means at least have one hold-means which in the form of the groove, channel, ditch, gap, construction, cut-outs which can hold the wire on position. Anyone can be treated as type of hold-means.

The hold-means well designed on the add-on piece or built-in piece to allow the wire has the input-end and output-end to easily make th eUSB's Plug and Charger-Plug to operation. The hold-mean has narrow diameter than the wire's diameter so can hold the wire tightly within the groove, ditch, channel, ditch at anywhere preferred so can fit for all kind of different length of the wire.

The bigger size of add-on soft elastic wire arrange-means needed for the smaller size or shallow (not thicker enough) of the safety approval USB Charger or USB charger related products. Because the contour path of the said SMALL USB Charger or USB Charger related products not enough to coil full length of the wire, so need to enlarge the add-on wire arrange-means contour so can have enough path of the groove, channels, ditchs, cutouts to coil all wire(s) which maybe not only Charger-USB wires but also has audio, video, internet, digital data transmitting wire(s). This is main feature shown on the FIG. 4.

While the USB Charger or USB Charger related product has good thickness or Bigger Contour path to allow all wire(s) been coil or arrangement or within, the Add-On or Build-in arrange-means can just follow the USB Charger or USB Charger related products contour shape with added some wall thickness and depth of the hold-means to make the hold-means for these USB Charger or USB Charger related products. This is main feature shown on the FIG. 4.

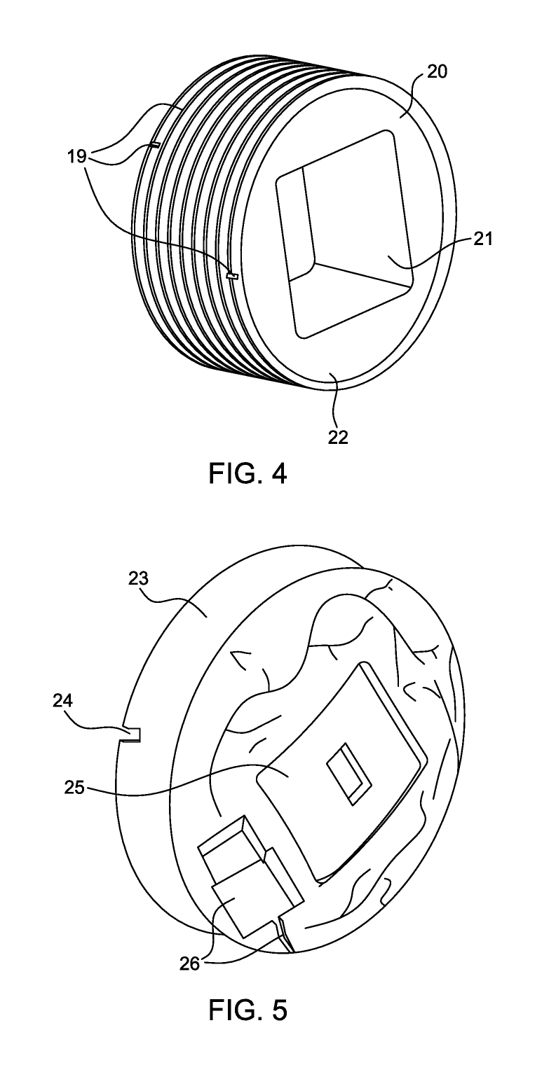

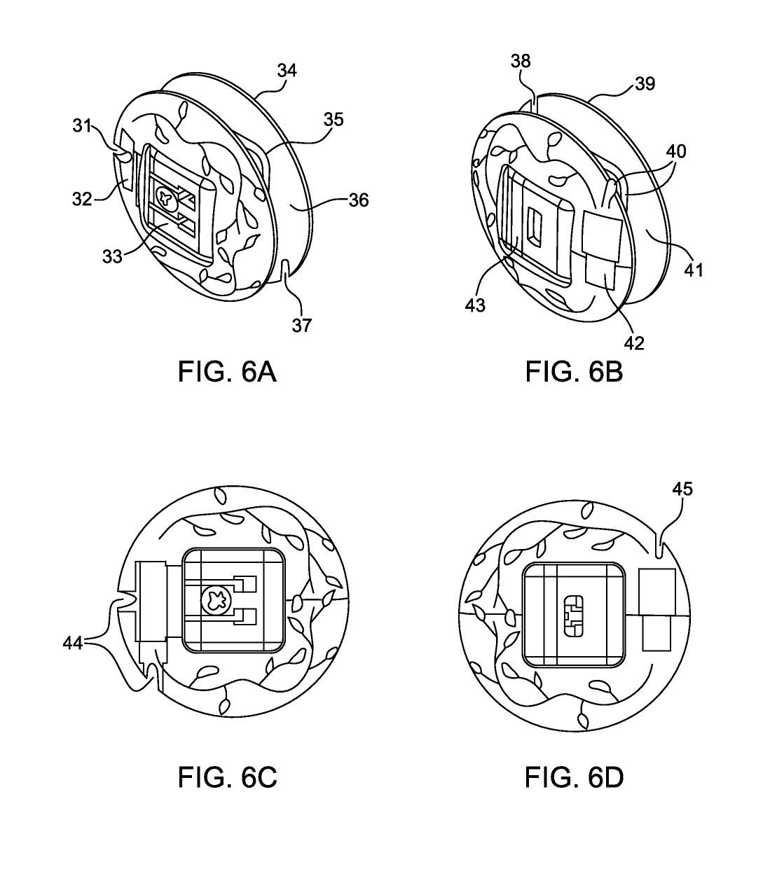

From FIG. 5 and FIG. 6-1, FIG. 6-2, FIG. 6-3, FIG. 6-4 with all details notes, All disclosure the Hold-means is several parts to form the construction, gap, space to allow the wire been fit within the said construction, gap, space with the several pools for the Charger plug or the USB plug to hold these plugs on position with some cutout(s) to allow the wire been hold at anytime. This kind of the construction for plurality of parts assembled together compare with sofe-elastic material simple arrange-means shown on FIG. 1, FIG. 2, FIG. 3, FIG. 4 has more features and also can received the Plug(s) on position are more high-end application of the current invention.

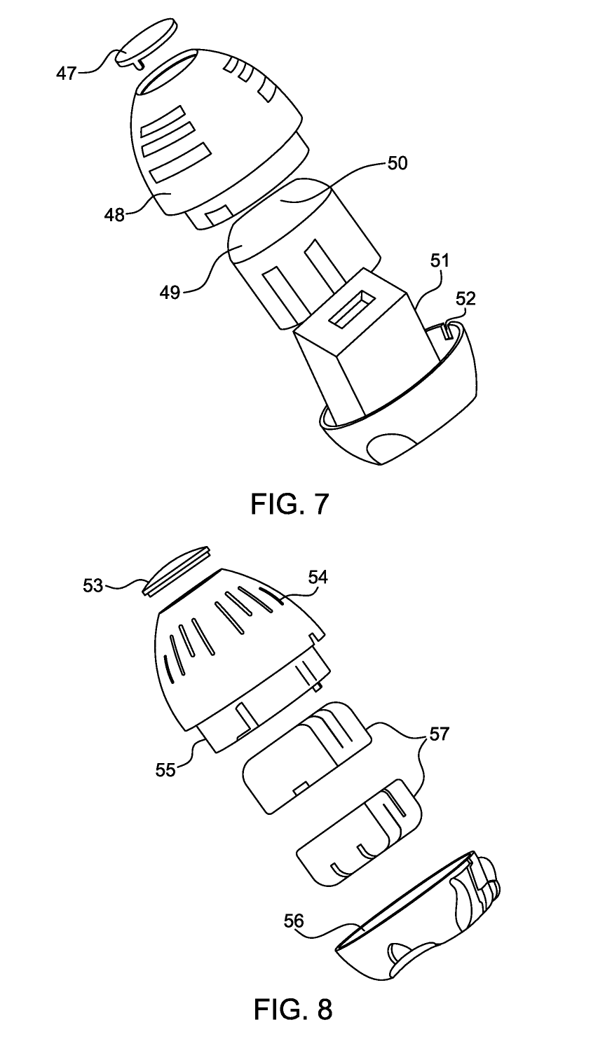

From FIG. 7 and FIG. 8 and FIG. 9, All disclosure the Add-On piece which for deluxe model to offer consumer more design and more convenient operation to coil or release wire by rotating the top cover to make the wire arrangement, After the 1^{st} installation (While the products not sell with Charger-USB wire), consumer just make 1 time setting, then, the coil or release wire can just simple rotating the top cover. If the products sell with the Charger-USB Wire included, the factory will pre-assembled the Charger-USB wire inside so consumer save time to make 1^{st} setting. The details construction will not discuss here because FIG. 7 and FIG. 8 and FIG. 9 are very details drawing to show how to make it works.

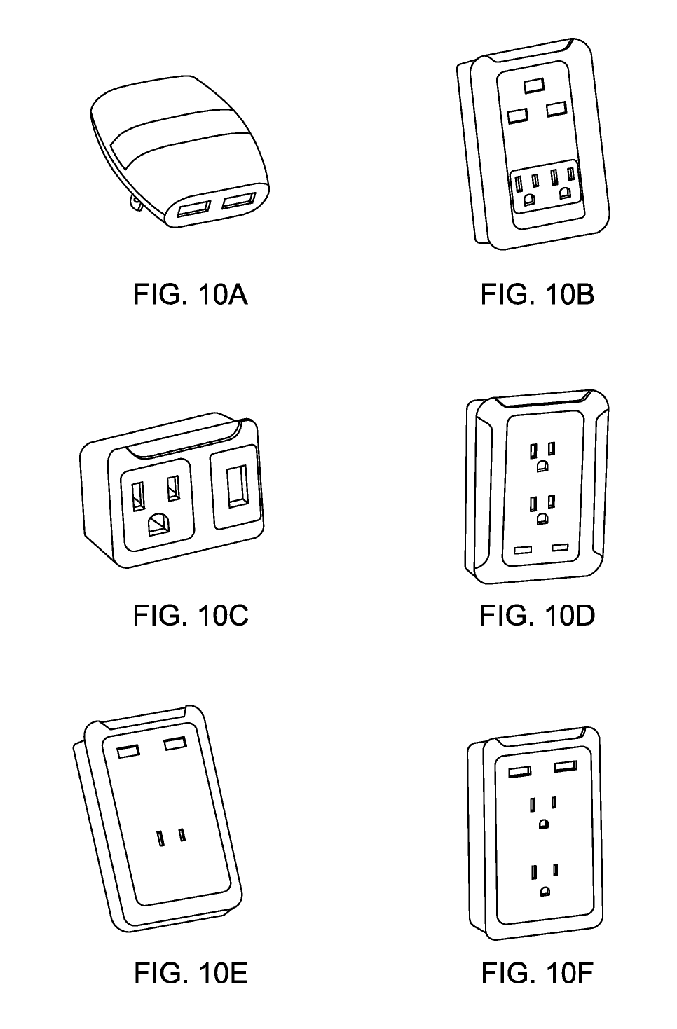

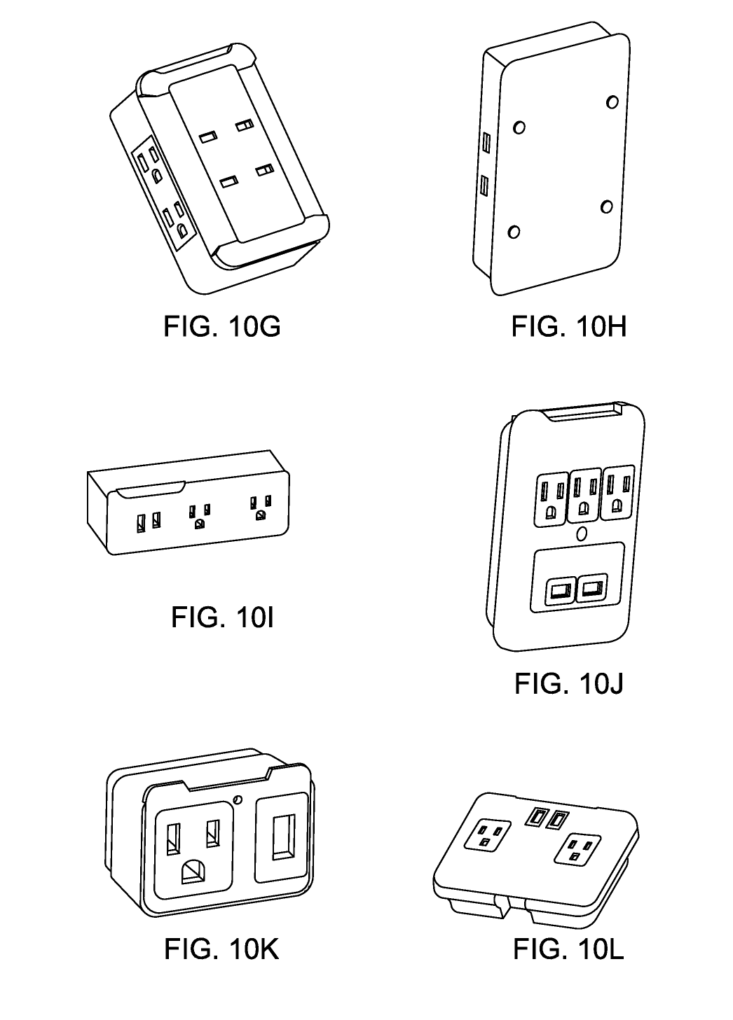

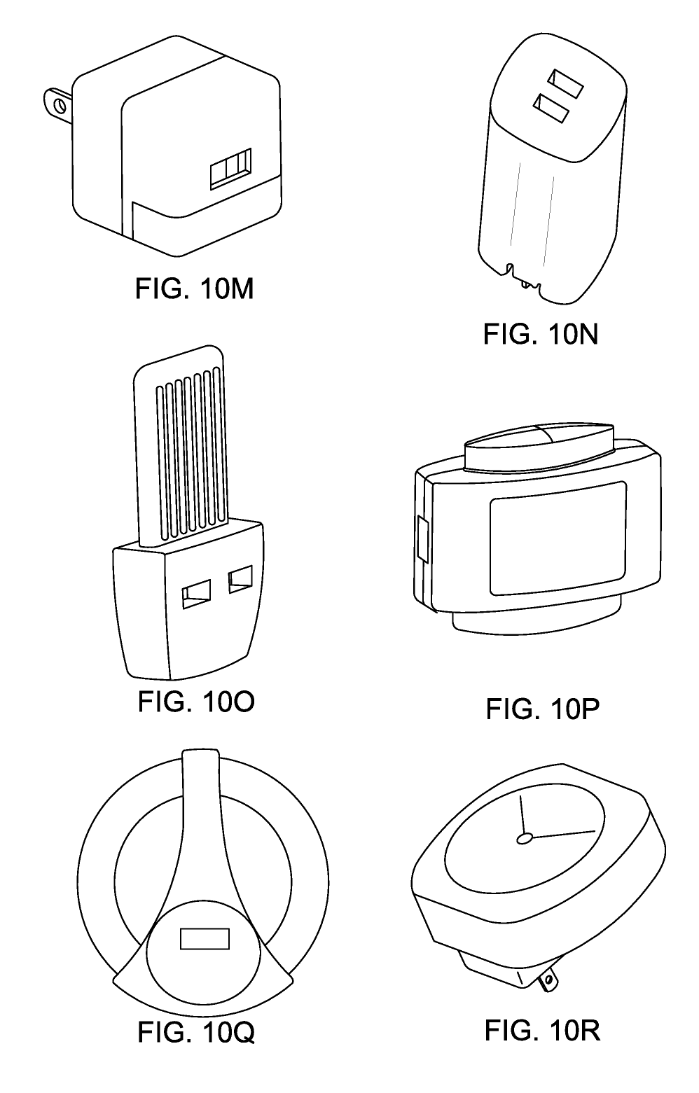

From FIG. 10 (#1 to #18) disclosure all preferred styles and all kind of the USB Charger related combinations which is not limited for these only 18 designs or combination. It is appreciated These #1 to #18, are the some and tiny embodiments, drawing, concepts of the current invention, It is appreciated, that any similar concept or equivalent application or same purpose or same physics theory or close acknowledgements still fall within the inventor's scope or wording or mind and claims coverage without any limitation as long as the same mind or concept or purpose to make the wire arrangement for USB Charger or USB Charger related products discussed or mentioned within this filing application in single word, phase, sentence or drawing notes.

The Each of the USB Charger related products shown on #1 to #18 has details notes and each one at least has more than one function(s) so it will waste the outlets space of house. While use any one of the listed No. 1 to No. 18 will get back a lot of convenient or advantage or practically functions from the current invention and most important has no more mess wires hanging these to ruin all nice home and sweet home taste and lovely accent by the Add-On or Built-in wire arrange-means of the current inventions. The more details and clear features as below 12 well organized sections.

The current invention has below 12 features:
1. The wire arrangement for USB Charger related products consist of:
   The USB Charger which at least has one of the USB receiving-means to connect with other electric or digital devices' USB plug-means and deliver electric signal from power source though USB charger to supply desire electric signal having certain voltage and current to other electric or digital device and get desire Function(s), Performance(s), Effect(s).
   The USB Charger related products means the product at least has one of the USB Charger incorporate with other device(s) for desire group combination select from USB Charger(s), Outlets device(s), Motion Sensor Device(s), Time device(s), Remote Control device(s), Infra-Red device(s), LED light device(s), Integrated circuit (hereafter as IC), control device(s), Sensor device(s) Light device(s), Infra-Red device(s), Sensor Device(s), Power fail device(s), Color Changing v.s. status Devices(s), Integrated Circuit device(s), Controller device(s), Smell Device(s), Motion device(s), audio device(s), Video device(s), Cable TV device(s), Internet device(s) or other market available electric or electronic device(s) to become the said products which has more than one function(s)
   The said wire arrange-means which has groove, ditch, channel, cut-outs
   Space to allow the Charger-USB's wire, or other device wire length can be well install while people use USB Charger to charge the electric or digital devices.
   The said wire arrange-means at least has one hold-means which to hold the Charger-USB's wire, or other device wire partial length or charger-plug or the USB plug on position and the said wire arrange-means in the form of Add-On piece or Build-In Piece for the said USB Charger or USB charger related product(s).
   The said Add-On wire arrange-means which are made by soft and elastic Material and it is separated with the said USB Charger or USB Charger related product(s) which can wrap, surround, attach, fit, adjacent to, or install on the contour of the USB Charger or the said USB Charger related products by groove, ditch, channel, cut-outs, space, hold-means so can install the said Charger-USB wire, or other device wire in good arrangement anytime.
   The said Build-In wire manage-means which are made of any material and at least one parts or plurality of parts assembled to form a wire arrangement kits has groove, ditch, channel, cut-outs, space, hold-means to install the said Charger-USB wire, or other device wire in good arrangement anytime.
The improvement including:
The Add-On or Build-In wire arrange-means has at least one hold-means which Can hold the said Charger-USB wire, or other device wire, or other device wire or the said USB-plug or the said Charger-plug on position to make Charger-USB wire, or other device wire, or other device wire on preferred arrangement while use, carry, travel by people.
The said Add-On wire arrange-means is a separated piece with the said USB Charger or the said Products which need to pass all relative safety standards and get the safety certification or records or documents so can add the ADD-ON wire arrange-means.
The Said Build-In wire arrange-means because the said groove, ditch, channel, cut-out, space are build in on the said USB Charger or the said Products surface, so the said Build-in wire arrange-means need to pass the safety related testament together with the said USB Charger or the said products together.
The said hold-means to hold the Charger-USB's, or other device wire at least of partial wire length or the said charger-plug or the said USB plug so the said hold-means need to very accurate size, specification for groove, channel, ditch, cut-outs, space so can hold the said wire, charger-plug, USB-plug tightly but easily to remove by force.
2. The Wire arrangement for the USB Charger related products as feature 1, The said Add-On arrange-means which design for wrap around the contour of the USB Charger or the said product so smaller product's contour length need to design the bigger contour add-on arrange-means to get enough contour length to install whole length of the said Charger-USB's wire, or other device wire.
3. The Wire arrangement for the USB Charger related products as feature 1, The said Add-On arrange-means which design for wrap around the contour of the USB Charger or the said products, The Bigger USB Charger or the said Product's has longer contour length only need a few coils of contour length can install whole Charger-USB wire, or other device wire length.
4. The Wire arrangement for the USB Charger related products as feature 1,
   The said USB related product has more than one functions which including for USB Charger, Outlets device(s), Motion sensor device(s), Remote control device(s), LED light device(s), Light device(s), Infra-Red device(s), Sensor Device(s), Power fail device(s), Color Changing v.s. status Devices(s), Integrated Circuit device(s), Controller device(s), Smell Device(s), Motion device(s), audio device(s), Video device(s), Cable TV device(s), Internet device(s) or any other electric or electronic device(s) functions in any combination to form a more than one function(s).
5. The Wire arrangement for the USB Charger related products as feature 1,
   The said hold-means hold at least partial length of wire, or other device wire, charger's plug, USB plug on fixed position means the location has cutout(s), groove(s), ditch(s), channel(s), Space(s) so the position can be fixed.
6. The Wire arrangement for the USB Charger related products as feature 1,
   The Add-On wire arrange-means made of soft and resilient material offer a shock-absorb function can prevent from the said USB Charger device or the said USB Charger related products been dropped to the hard surface.
7. The Wire arrangement for the USB Charger related products as feature 1,
   The preferred screw-thread or the similar skill from input-end to the output-end of the groove, ditch, channel, cut-outs, space, gaps, construction is a continuously linear arrangement for smooth the wire direction for easily coil or release purpose.
8. The Wire arrangement for the USB Charger related products as feature 1,
   The depth of the said groove, ditch, channel, cutouts preferred deeper than the Charger-USB wire or other wire(s) diameter or depth deeper than the Charger-plug or USB-Plug with easily finger shallow to easily Remove or release from hold position.
9. The Wire arrangement for the USB Charger related products as feature 1,
   The width of the said groove, ditch, channel, cutouts preferred smaller than the Charge-USB wire's or other devices' wire's diameter so can fit tight to hold on position.
10. The Wire arrangement for the USB Charger related products as feature 1,
   The said Add-On wire arrange-means piece can replace, remove, separated from the said USB Charger or USB Charger related device While needed.
11. The Add-On Wire arrangement piece for the USB Charger device or USB Charger related products consist of;
   At least one of soft and elastic material Add-On wire-arrange means with grooves, channels, gaps, ditch, cut-out(s), space as a hold-means to make Charger-USB's wire or other device(s) wire, or Charger-plug, or USB-Plug hold on the position.
   The said USB charger or USB charger related products has at least one of the USB Charger incorporate with device(s) in group combinations selected from more USB charger device(s), Outlet device(s), LED light device(s), Time piece device(s), Motion Sensor device(s), Remote control device(s), Smell Device(s), Motion Device(s), Animation Device(s), audio device(s), Video device(s), Internet device(s), or other electric or electronic device(s) available from market place to become a more than one function(s) product(s).
   The said Add-on Wire arrange-means is separated piece and can install to the said USB Charger or the USB Charger related products which has passed safety certification without the said wire arrange-means.
12. The USB Charger or USB Charger related products has Built-In Wire arrangement features consist of;
   The said USB charger or USB charger related products has at least one of the USB Charger incorporate with device(s) in group combinations selected from more USB charger device(s), Outlet device(s), LED light device(s), Time piece device(s), Motion Sensor device(s), Remote control device(s), Smell Device(s), Motion Device(s), Animation Device(s), audio device(s), video device(s), Internet device(s), digital data device(s) or other electric or electronic device(s) available from market place to become a more than one function(s) product(s).
   At least one of surface or space or construction or parts of the said USB charger or USB Charger related product has grooves, channels, gaps, ditch, cut-out(s), space, construction, design to hold the said Charger-USB's wire or other device(s)′ wire, or the said Charger-plug, or the said USB-Plug fix on the position of the said USB Charger or USB Charger related product(s) housing by at least one of the hold-means.
   The said USB Charger or the USB Charger related products has the wire arrange-means is built-in within the USB Charger or the USB charger related products.

1. The wire arrangement for USB Charger related products consist of:
The USB Charger which at least has one of the USB receiving-means to connect with other electric or digital devices' USB plug-means and deliver electric signal from power source though USB charger to supply desire electric signal having certain voltage and current to other electric or digital device and get desire Function(s), Performance(s), Effect(s).
The USB Charger related products means the product at least has one of the USB Charger incorporate with other device(s) for desire group combination select from USB Charger(s), Outlets device(s), Motion Sensor Device(s), Time device(s), Remote Control device(s), Infra-Red device(s), LED light device(s), Integrated circuit (hereafter as IC), control device(s), Sensor device(s) Light device(s), Infra-Red device(s), Sensor Device(s), Power fail device(s), Color Changing v.s. status Devices(s), Integrated Circuit device(s), Controller device(s), Smell Device(s), Motion device(s), audio device(s), Video device(s), Cable TV device(s), Internet device(s) or other market available electric or electronic device(s) to become the said products which has more than one function(s)
The said wire arrange-means which has groove, ditch, channel, cut-outs Space to allow the Charger-USB's wire, or other device wire length can be well install while people use USB Charger to charge the electric or digital devices.
The said wire arrange-means at least has one hold-means which to hold the Charger-USB's wire, or other device wire partial length or charger-plug or the USB plug on position and the said wire arrange-means in the form of Add-On piece or Build-In Piece for the said USB Charger or USB charger related product(s).
The said Add-On wire arrange-means which are made by soft and elastic Material and it is separated with the said USB Charger or USB Charger related product(s) which can wrap, surround, attach, fit, adjacent to, or install on the contour of the USB Charger or the said USB Charger related products by groove, ditch, channel, cut-outs, space, hold-means so can install the said Charger-USB wire, or other device wire in good arrangement anytime.
The said Build-In wire manage-means which are made of any material and at least one parts or plurality of parts assembled to form a wire arrangement kits has groove, ditch, channel, cut-outs, space, hold-means to install the said Charger-USB wire, or other device wire in good arrangement anytime.
The improvement including:
The Add-On or Build-In wire arrange-means has at least one hold-means which Can hold the said Charger-USB wire, or other device wire, or other device wire or the said USB-plug or the said Charger-plug on position to make Charger-USB wire, or other device wire, or other device wire on preferred arrangement while use, carry, travel by people.
The said Add-On wire arrange-means is a separated piece with the said USB Charger or the said Products which need to pass all relative safety standards and get the safety certification or records or documents so can add the ADD-ON wire arrange-means.
The Said Build-In wire arrange-means because the said groove, ditch, channel, cut-out, space are build in on the said USB Charger or the said Products surface, so the said Build-in wire arrange-means need to pass the safety related testament together with the said USB Charger or the said products together.
The said hold-means to hold the Charger-USB's, or other device wire at least of partial wire length or the said charger-plug or the said USB plug so the said hold-means need to very accurate size, specification for groove, channel, ditch, cut-outs, space so can hold the said wire, charger-plug, USB-plug tightly but easily to remove by force.

2. The Wire arrangement for the USB Charger related products as claim 1, The said Add-On arrange-means which design for wrap around the contour of the USB Charger or the said product so smaller product's contour length need to design the bigger contour add-on arrange-means to get enough contour length to install whole length of the said Charger-USB's wire, or other device wire.

3. The Wire arrangement for the USB Charger related products as claim 1, The said Add-On arrange-means which design for wrap around the contour of the USB Charger or the said products, The Bigger USB Charger or the said Product's has longer contour length only need a few coils of contour length can install whole Charger-USB wire, or other device wire length.

4. The Wire arrangement for the USB Charger related products as claim 1, The said USB related product has more than one functions which including for USB Charger, Outlets device(s), Motion sensor device(s), Remote control device(s), LED light device(s), Light device(s), Infra-Red device(s), Sensor Device(s), Power fail device(s), Color Changing v.s. status Devices(s), Integrated Circuit device(s), Controller device(s), Smell Device(s), Motion device(s), audio device(s), Video device(s), Cable TV device(s), Internet device(s) or any other electric or electronic device(s) functions in any combination to form a more than one function(s).

5. The Wire arrangement for the USB Charger related products as claim 1, The said hold-means hold at least partial length of wire, or other device wire, charger's plug, USB plug on fixed position means the location has cutout(s), groove(s), ditch(s), channel(s), Space(s) so the position can be fixed.

6. The Wire arrangement for the USB Charger related products as claim 1, The Add-On wire arrange-means made of soft and resilient material offer a shock-absorb function can prevent from the said USB Charger device or the said USB Charger related products been dropped to the hard surface.

7. The Wire arrangement for the USB Charger related products as claim 1, The preferred screw-thread or the similar skill from input-end to the output-end of the groove, ditch, channel, cut-outs, space, gaps, construction is a continuously linear arrangement for smooth the wire direction for easily coil or release purpose.

8. The Wire arrangement for the USB Charger related products as claim 1, The depth of the said groove, ditch, channel, cutouts preferred deeper than the Charger-USB wire or other wire(s) diameter or depth deeper than the Charger-plug or USB-Plug with easily finger shallow to easily Remove or release from hold position.

9. The Wire arrangement for the USB Charger related products as claim 1, The width of the said groove, ditch, channel, cutouts preferred smaller than the Charge-USB wire's or other devices' wire's diameter so can fit tight to hold on position.

10. The Wire arrangement for the USB Charger related products as claim 1, The said Add-On wire arrange-means piece can replace, remove, separated from the said USB Charger or USB Charger related device While needed.

11. The Add-On Wire arrangement piece for the USB Charger device or USB Charger related products consist of;
At least one of soft and elastic material Add-On wire-arrange means with grooves, channels, gaps, ditch, cut-out(s), space as a hold-means to make Charger-USB's wire or other device(s) wire, or Charger-plug, or USB-Plug hold on the position.
The said USB charger or USB charger related products has at least one of the USB Charger incorporate with device(s) in group combinations selected from more USB charger device(s), Outlet device(s), LED light device(s), Time piece device(s), Motion Sensor device(s), Remote control device(s), Smell Device(s), Motion Device(s), Animation Device(s), audio device(s), Video device(s), Internet device(s), or other electric or electronic device(s) available from market place to become a more than one function(s) product(s).
The said Add-on Wire arrange-means is separated piece and can install to the said USB Charger or the USB Charger related products which has passed safety certification without the said wire arrange-means.

12. The USB Charger or USB Charger related products has Built-In Wire arrangement features consist of;
The said USB charger or USB charger related products has at least one of the USB Charger incorporate with device(s) in group combinations selected from more USB charger device(s), Outlet device(s), LED light device(s), Time piece device(s), Motion Sensor device(s), Remote control device(s), Smell Device(s), Motion Device(s), Animation Device(s), audio device(s), video device(s), Internet device(s), digital data device(s) or other electric or electronic device(s) available from market place to become a more than one function(s) product(s).
At least one of surface or space or construction or parts of the said USB charger or USB Charger related product has grooves, channels, gaps, ditch, cut-out(s), space, construction, design to hold the said Charger-USB's wire or other device(s)′ wire, or the said Charger-plug, or the said USB-Plug fix on the position of the said USB Charger or USB Charger related product(s) housing by at least one of the hold-means.
The said USB Charger or the USB Charger related products has the wire arrange-means is built-in within the USB Charger or the USB charger related products.
